(19) United States
(12) Patent Application Publication
(10) Pub. No.: US 2002/0112668 A1
(43) Pub. Date: Aug. 22, 2002

(54) Apparatus for feeding and/or watering animals

(75) Inventor: Adriaan Coert van Lenteren, Maasland (NL)

Correspondence Address: Penrose Lucas Albright, Esq., MASON, MASON & ALBRIGHT, P.O. Box 2246, Arlington, VA, 22202-0246, US

(73) Assignee: LELY ENTERPRISES AG

(21) Appl. No.: 10/078,491

(22) Filed: Feb. 21, 2002

(30) Foreign Application Priority Data
Feb. 22, 2001 (NL) 1017431

(51) Int. Cl. A01K 1/10; A01K 5/00; A01K 39/00

(52) U.S. Cl. 119/53.5

(57) ABSTRACT

In an apparatus for feeding and/or watering animals by means of a supply device (4) for fodder and/or drink at which the animals can suck and/or lick the supply device (4) is fixedly disposed in relation to the apparatus. The apparatus is further provided with a preventing device (7) capable of being activated and deactivated, which preventing device (7), when active, is adapted to prevent an animal from sucking and/or licking at the supply device (4). As a result thereof the apparatus encounters little wear and can be designed solidly. By means of the preventing device (7) the use of the supply device (4) can be controlled.

The invention relates to an apparatus for feeding and/or watering animals according to the preamble of claim 1.

Such apparatuses are known and comprise a shiftably disposed supply device. A disadvantage thereof is inter alia that also the supply lines to the supply device have to be designed movably. Furthermore, wear of the movable parts occurs after some time.

The invention aims at improving such an apparatus. According to the invention this is achieved by the measures in the characterizing part of claim 1. The fixed supply device encounters little wear. Consequently the useful life of the apparatus is influenced positively. Moreover, the supply lines may also be fixedly disposed so that a solid apparatus is obtained. The preventing device ensures that the use of the supply device can be controlled.

The invention will now be explained in further detail with reference to the accompanying figures.

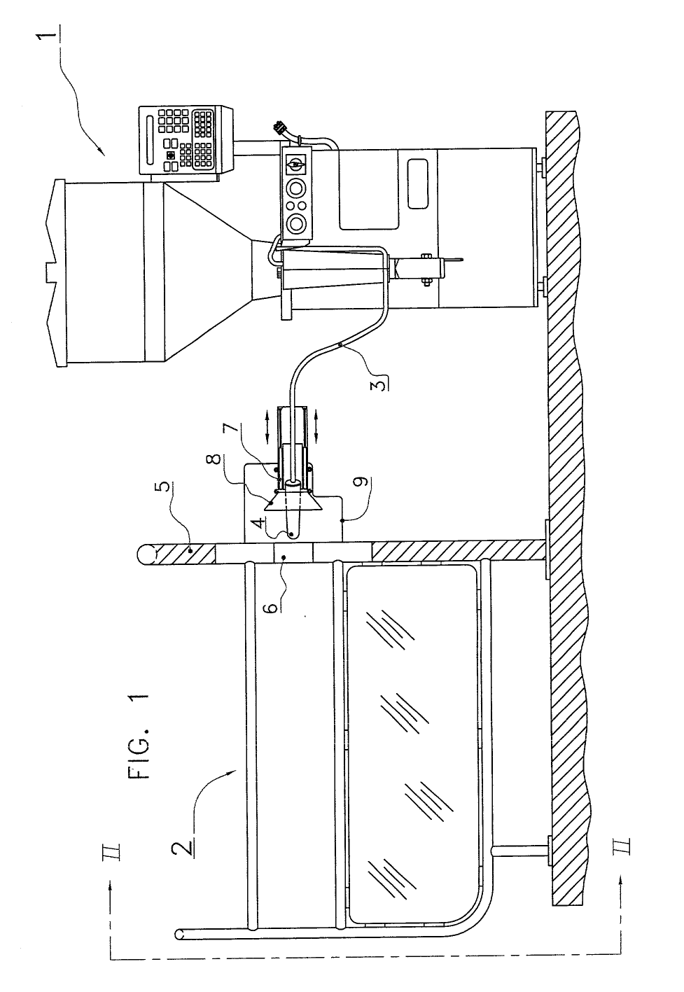

FIG. 1 is a side view of an apparatus according to the invention;

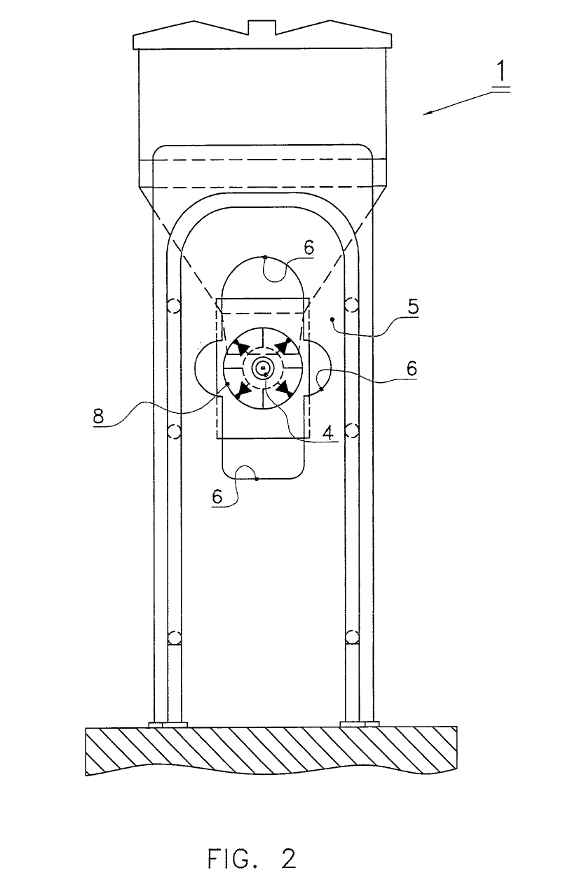

FIG. 2 is a view of the apparatus according to the arrows II-II in FIG. 2, and

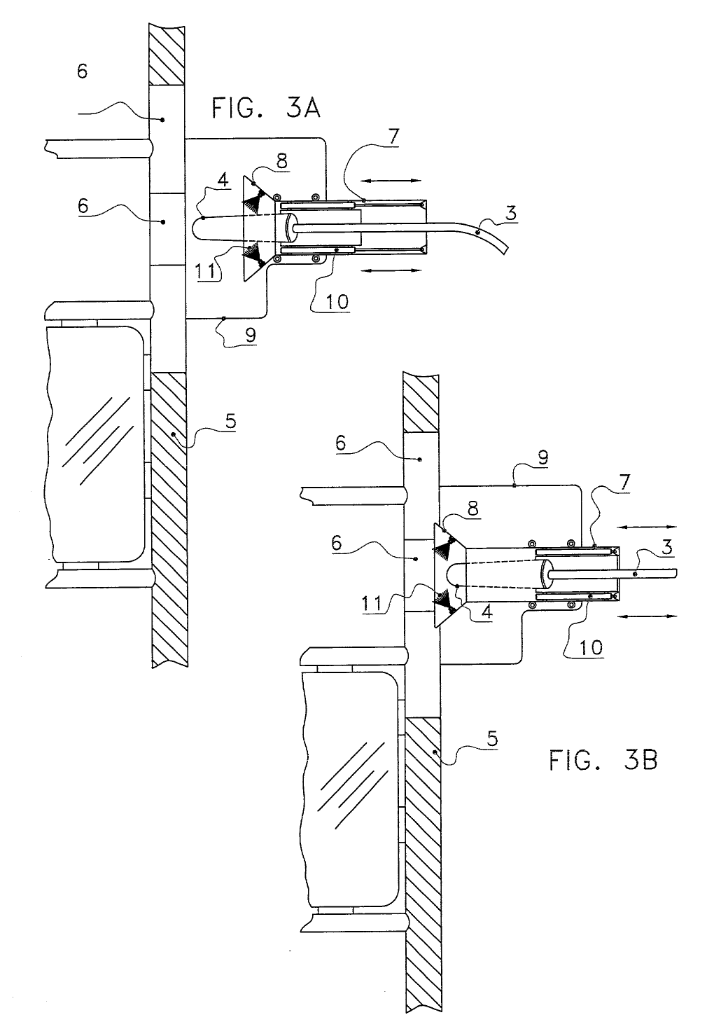

FIG. 3 shows a detail of the apparatus in two different positions.

FIG. 1 is a side view of an apparatus according to the invention. A feeding unit 1 known per se comprises a reservoir for fodder and/or drink, a metering device and a programmable control unit such as a computer for possibly mixing and metering the fodder and/or the drink. A feeding parlour 2 is provided with gates for positioning an animal wishing to eat or drink. The feeding parlour 2 is possibly provided with animal identification means for recognising an animal that visits the feeding parlour for taking fodder or drink. Said identification means are able to co-operate with the computer in the feeding unit 1, so that an individual supply of feed is possible. By feed is each time also meant drink or a mixture of fodder and drink. The apparatus is in particular suitable for feeding young animals, such as calves, with principally liquid food.

In the embodiment shown in FIG. 1 the feeding unit 1 is connected with the feeding parlour 2 via a supply line 3. The supply line for supplying feed debouches near the feeding parlour 2 into a teat-like supply device 4 that is adapted to supply feed to an animal that sucks or licks at it. The supply device 4 is fixedly fastened in relation to the feeding parlour 2, e.g. to a part of the fencing that is adjacent to the feeding parlour 2 in the direction of the Feeding unit 1. In the embodiment shown the supply device 4 is disposed behind a wall 5 with an entrance opening 6 for the snout of an animal. The animal can put its snout through the opening 6 in order to reach the supply device 4.

According to the invention the apparatus is further provided with a preventing device 7 which is capable of being activated and deactivated and which, when active, is adapted to prevent an animal from sucking and/or licking at the supply device 4. In FIG. 1 the preventing device 7 is designed so as to be substantially sleeve-shaped or cylindrical and movable in relation to the apparatus between a first, deactivated position and a second, activated position, as will be explained hereinafter in further detail. Other designs of the preventing device 7 are possible as well.

The portion 8 of the preventing device 7 that is located closest to the animal serves as pushing-away portion for the snout of the animal and is preferably ring-shaped, sleeve-shaped, conical or cylindrical. The supply device 4 and the preventing device 7 are disposed substantially co-axially and are capable of being shifted in axial direction in relation to each other.

This is further elucidated in the further figures. FIG. 2 is a view of the apparatus according to the arrows II-II in FIG. 1, and FIG. 3 shows the preventing device 7 of the apparatus in two different positions. The brackets 9 serve for fastening to the feeding parlour 2. The opening or recess 6 in the wall 5 may have various shapes, of course.

FIG. 3A shows the preventing device 7 in its first, deactivated position. Via the opening 6 in the wall 5 the supply device 4 is freely accessible to the snout of an animal that is going to occupy the feeding parlour 2. In FIG. 3B the preventing device 7 is in its second, activated position. By means of control cylinders 10 the pushing-away portion 8 has now been shifted so far in the direction of the animal that its snout can no longer reach the supply device 4. In said second position the preventing device 7 surrounds the supply device 4 for the greater part. Of course, the cylinders 10 are dimensioned such that they are able to push the snout of an animal that is standing in the feeding parlour 2 in rearward direction.

The apparatus is preferably provided with cleaning and/or disinfecting means for the supply device 4. Said cleaning and/or disinfecting means may be disposed at least partially on and/or in the preventing device 7. At least in the second position, in which the supply device 4 is surrounded by the preventing device 7, they are adapted to be activated for cleaning and/or disinfecting the supply device 4.

In a compact embodiment the cleaning and/or disinfecting means are substantially disposed on the inside of the preventing device 7. In this situation the preventing device 7 may at least partially be designed so as to be double-walled in such a manner that water and/or a cleansing agent and/or a disinfectant can be passed between the walls. The preventing device 7 may further be provided on the inside with apertures for supplying water and/or a cleansing agent and/or a disinfectant to the supply device 4.

In the embodiment shown in the figures the pushing-away portion 8 is conical and provided on the inside with means, such as sprayers 11, for supplying water and/or a cleansing agent and/or a disinfectant to the supply device 4.

The pushing-away portion 8 may be adapted to be located substantially against the wall 5 in the second position. In this situation the pushing-away portion 8 closes the opening 6 to such an extent that the animal can no longer reach the supply device 4 with its snout. In another, non-shown embodiment, the pushing-away portion 8 is adapted to close the entrance opening 6 almost completely in the second position.

In a further, non-shown embodiment, the preventing device 7 comprises means for spraying a fluid, such as liquid or air or another gas in the direction of the snout of an animal. The animals finds this unpleasant and will draw back its snout. This embodiment has the advantage that the preventing device 7 needs not to comprise movable parts.

The preventing device 7 may also be designed as a shiftable wall portion with an entrance opening for the snout of an animal. In this manner it is also achieved that an animal can temporarily no longer reach the teat 4.

The apparatus may be provided with means for giving a warning signal before the preventing device 7 is activated. The animal is thus alerted and can draw back its snout in time.

Instead of the feeding unit 1 with the teat 4 and the supply line 3, there may for example also be provided a salt stick at which an animal can lick.

The invention also relates to an apparatus for feeding and/or watering animals by means of a supply device for fodder and/or drink at which the animals can suck and/or lick, characterized in that the apparatus is provided with a substantially ring-shaped or cylindrical preventing device, the supply device and the preventing device being disposed so as to be capable of performing in relation to each other a relative movement between a first position in which an animal can suck and/or lick at the supply device and a second position in which the preventing device prevents an animal from sucking and/or licking at the supply device. In this situation the supply device is not necessarily fixedly disposed in relation to the apparatus. In this manner the supply device is protected in the second position by the preventing device.

1. An apparatus for feeding and/or watering animals by means of a supply device (4) for fodder and/or drink at which the animals can suck and/or lick, characterized in that the supply device (4) is fixedly disposed in relation to the apparatus, the apparatus being provided with a preventing device (7) capable of being activated and deactivated, which preventing device (7), when active, is adapted to prevent an animal from sucking and/or licking at the supply device (4).

2. An apparatus as claimed in claim 1, characterized in that the preventing device (7) is disposed so as to be movable in relation to the apparatus between a first, deactivated position and a second, activated position.

3. An apparatus as claimed in claim 1 or 2, characterized in that the preventing device (7) is designed so as to be substantially ring-shaped or cylindrical.

4. An apparatus as claimed in any one of claims 1 to 3, characterized in that the supply device (4) and the preventing device (7) are disposed substantially co-axially and are capable of being shifted in axial direction in relation to each other.

5. An apparatus as claimed in any one of claims 2 to 4, characterized in that the preventing device (7) substantially surrounds the supply device (4) at least in the second position.

6. An apparatus as claimed in any one of claims 1 to 5, characterized in that the supply device (4) is substantially designed as a teat.

7. An apparatus as claimed in any one of claims 1 to 6, characterized in that the apparatus is provided with cleaning and/or disinfecting means (11) for the supply device (4).

8. An apparatus as claimed in claim 7, characterized in that the cleaning and/or disinfecting means (11) for the supply device (4) are disposed at least partially on and/or in the preventing device (7).

9. An apparatus as claimed in any one of claims 7 and 8, characterized in that the cleaning and/or disinfecting means (11) are capable of being activated at least in the second position.

10. An apparatus as claimed in any one of claims 8 and 9, characterized in that the cleaning and/or disinfecting means (11) are substantially disposed on the inside of the preventing device (7).

11. An apparatus as claimed in any one of claims 7 to 10, characterized in that the preventing device (7) is at least partially designed so as to be double-walled in such a manner that water and/or a cleansing agent and/or a disinfectant can be passed between the walls.

12. An apparatus as claimed In any one of claims 7 to 11, characterized in that the preventing device (7) is provided on the inside with apertures for supplying water and/or a cleansing agent and/or a disinfectant to the supply device (4).

13. An apparatus as claimed in any one of claims 1 to 12, characterized in that the preventing device (7) is provided with a pushing-away portion (8) for the snout of an animal.

14. An apparatus as claimed in claim 13, characterized in that the pushing-away portion (8) is designed so as to be ring-shaped, cylindrical or conical.

15. An apparatus as claimed in any one of claims 13 and 14, characterized in that the pushing-away portion (8) is provided with means (11) for supplying water and/or a cleansing agent and/or a disinfectant to the supply device (4).

16. An apparatus as claimed in any one of claims 1 to 15, characterized in that the supply device (4) and the preventing device (7) are disposed behind a wall (5) with an entrance opening (6) for the snout of an animal.

17. An apparatus as claimed in any one of claims 13 to 15 and claim 16, characterized in that the pushing-away portion (8) is adapted to be located substantially against the wall (5) in the second position.

18. An apparatus as claimed in any one of claims 16 and 17, characterized in that the pushing-away portion (8) is adapted to close the entrance opening (6) substantially completely in the second position.

19. An apparatus as claimed in any one of claims 1 to 18, characterized in that the preventing device (7) comprises means for spraying a fluid in the direction of the snout of an animal.

20. An apparatus as claimed in any one of claims 1 to 19, characterized in that the apparatus is provided with means for giving a warning signal before the preventing device (7) is activated.

21. An apparatus as claimed in any one of claims 1 to 20, characterized in that the preventing device (7) is designed as a shiftable wall portion with an entrance opening for the snout of an animal.

22. An apparatus for feeding and/or watering animals by means of a supply device for fodder and/or drink at which the animals can suck and/or lick, characterized in that the apparatus is provided with a substantially ring-shaped or cylindrical preventing device, the supply device and the preventing device being disposed so as to be capable of performing in relation to each other a relative movement between a first position in which an animal can suck and/or lick at the supply device and a second position in which the preventing device prevents an animal from sucking and/or licking at the supply device.
